(19) United States
(12) Patent Application Publication
(10) Pub. No.: US 2006/0236244 A1
(43) Pub. Date: Oct. 19, 2006

(54) Command links

(75) Inventors: Mark D. Coburn, Sammamish, WA (US); Harold S. Gomez, Seattle, WA (US); Jan T. Miksovsky, Seattle, WA (US); Jeffrey S. Miller, Woodinville, WA (US); Vincent J. Pasceri, Redmond, WA (US); Charles W. Stabb, Seattle, WA (US); Randall K. Winjum, Vashon, WA (US)

Correspondence Address: BANNER & WITCOFF LTD.,;ATTORNEYS FOR CLIENT NOS. 003797 & 013797, 1001 G STREET , N.W., SUITE 1100, WASHINGTON, DC, 20001-4597, US

(73) Assignee: Microsoft Corporation, Redmond, WA (US)

(21) Appl. No.: 11/106,723

(22) Filed: Apr. 15, 2005

(51) Int. Cl. G06F 17/00

(52) U.S. Cl. 715/710; 715/711

(57) ABSTRACT

A command link input control has a main title portion describing a user input option corresponding to selection of that command link. Upon selection of the command link, a dialog containing that command link is completed without requiring a user to select additional input controls. The command link may optionally contain a subtitle portion for providing supplementary text further explaining or otherwise elaborating upon the option corresponding to the command link. The command link may also contain a glyph. Upon hovering a cursor over a command link or otherwise indicating potential selectability of the command link, the entire link is highlighted by, e.g., altering the background color of the display region containing the main title, subtitle and/or glyph.

### FIELD OF THE INVENTION

The invention generally relates to computer user interfaces (UIs) and to creation of user interfaces. More specifically, embodiments of this invention relate to graphically represented controls within a UI and to programming interfaces allowing software developers to more conveniently create such controls.

### BACKGROUND OF THE INVENTION

There are various known types of input controls which can be included in a graphical user interface (GUI) of a computer. More particularly, software developers have devised multiple ways in which a computer program may generate a graphical mechanism for a user to select an input option. For example, many user interfaces will display a question or statement (e.g., “do you want to save this file”) and images of several buttons corresponding to possible responses. Each of those buttons may be labeled with a response (e.g., “yes,” “no,” “ok,” “cancel,” etc.). A user may then select one of those options by placing a cursor over the button corresponding to the desired option and clicking a physical button on the mouse.

Although it is a good choice for many types of input options, a simple command button does have limitations. For instance, it is sometimes beneficial to provide a user with a more detailed description of several possible input options. However, it can be inconvenient if these additional details are not located near the corresponding controls. As an illustration, assume a user is presented with a dialog UI for configuring user accounts on a computer. As possible choices, an account could be a “limited” or “administrator” account. Because there are implications to either choice that may not be readily apparent to all users, it can be helpful to include additional text describing the two options. For example, a limited account may not be able to change certain computer settings, access certain files or install certain programs; an administrator may have unrestricted access. If the UI dialog simply has a lengthy paragraph describing the implications of either option and provides buttons for each option labeled with a terse description (e.g., “limited” and “administrator”), the user can become distracted. After reading the long paragraph describing the options, the user has to recall specifics of each option based on the terse descriptions. Although different labels could be used for the command buttons corresponding to the two options, it can become impractical to include lengthy text strings for such labels.

Various other types of input controls have been developed to address this problem. On such control is the ubiquitous “radio button.” Such a control typically displays one or more lines of text for each possible input option. Next to the text for each option is a small circle or other region which a user can select with a mouse. Once selected, the region is filled with a black dot or other indication of the selection. Typically, only one of the options can be selected. If a user selects one option and then selects another of the options, the black dot for the first selection is removed. The user then indicates that he or she has made a final decision by pressing a separate command button (e.g., labeled “ok”).

Radio buttons are useful when it is desirable to locate additional text near a control which the user selects to make a choice. Radio buttons do have at least one disadvantage, however. In particular, radio buttons require a user to perform at least two operations to make a selection: selecting the appropriate radio button and then selecting an “ok” (or other) command button. Although this may at first seem insignificant, it is important to remember that computer users may perform numerous operations requiring them to select one of multiple options. Over time, having to perform two mouse movements and mouse button presses for each selection can become inconvenient.

For these and other reasons, there remains a need for user input controls that allow a user to conveniently receive additional description of an input option, but which also minimize the number of movements required for selecting a particular option.

### SUMMARY OF THE INVENTION

Embodiments of the invention address these and other challenges. In at least some embodiments, the invention includes a command link input control having a main title portion describing an input option corresponding to selection of that command link. Upon selection of the command link, a dialog containing that command link is completed without requiring a user to select additional input controls. The command link may optionally contain a subtitle portion for providing supplementary text further explaining or otherwise elaborating upon the command link. The command link may also contain a glyph.

Upon a user hovering a cursor over a command link, the entire region of a display containing the command link is highlighted. In this manner, the user can easily determine all text that relates to the input option corresponding to that command link. The command link region can be highlighted by, e.g., altering the background color of that region. The command link region can also be highlighted in different manners so as to indicate different states.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention.

FIG. 1A is a block diagram of an example of a computing system environment in which embodiments of the invention may be implemented.

FIGS. 1B through 1M show programming interfaces, in a general-purpose computer environment, with which one or more embodiments of the present invention may be implemented.

FIGS. 2A-2F are examples of command link input controls according to at least some embodiments of the invention.

FIG. 3 is a block diagram showing generation of command links in response to a request from an application program.

FIGS. 4A and 4B illustrate an advantage of command link input controls.

### DETAILED DESCRIPTION OF THE PREFERRED EMBODIMENTS

The following detailed description is divided into three parts. Part I describes an example of a computer system environment in which embodiments of the invention may be implemented. Part II describes examples of at least some programming interfaces which can be used to implement embodiments of the invention. Part III describes embodiments of command link user interface (UI) controls and methods for implementing command links.

I. Example Computing System Environment

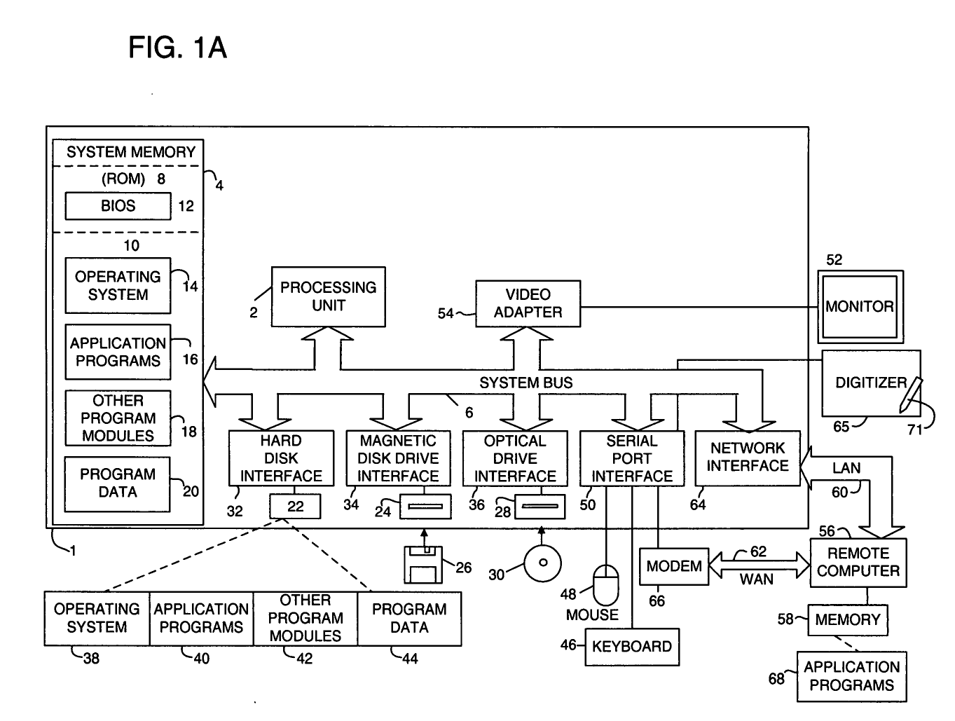

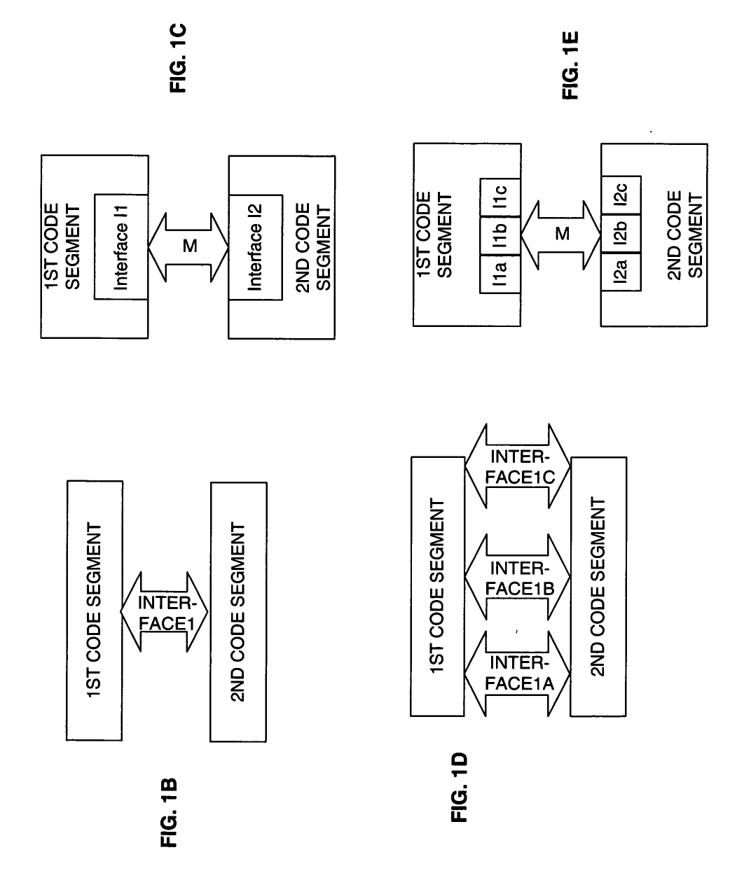

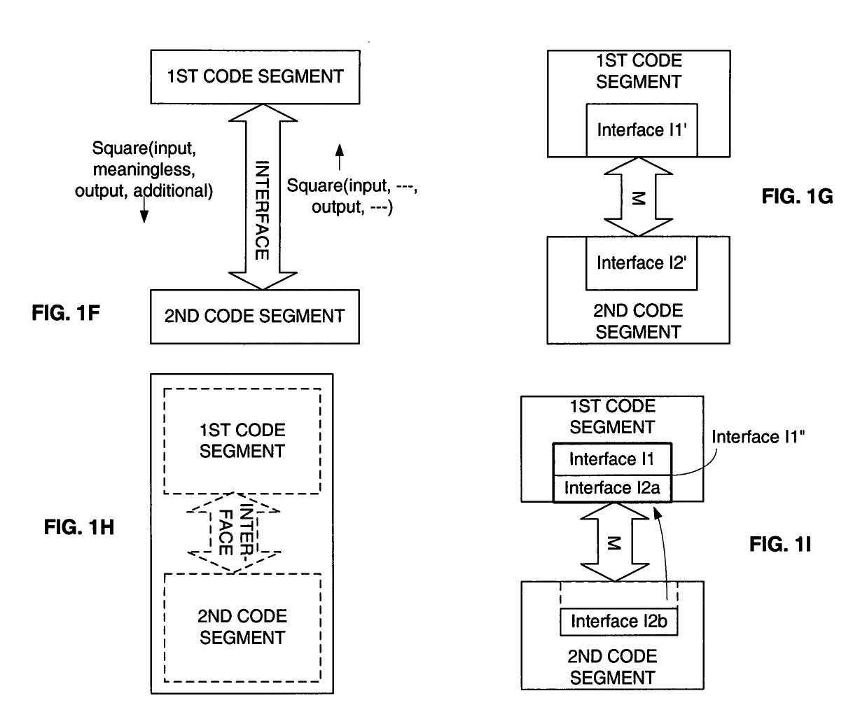

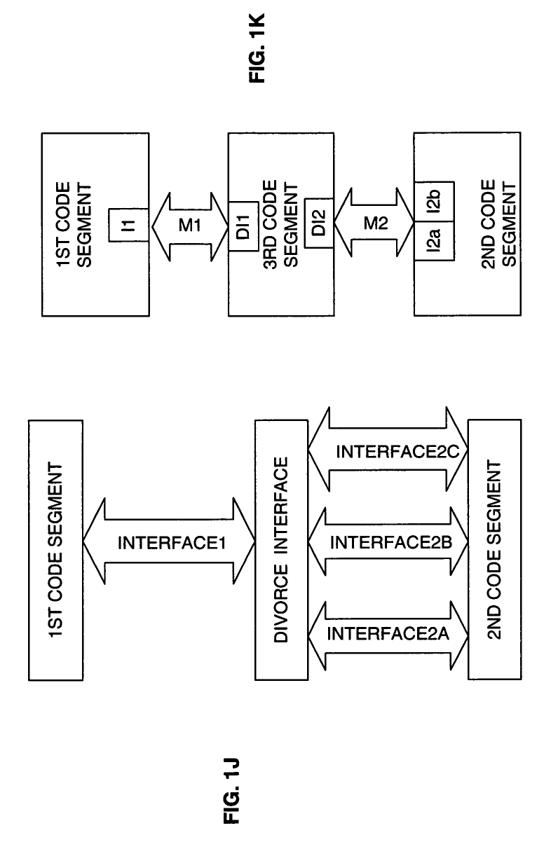

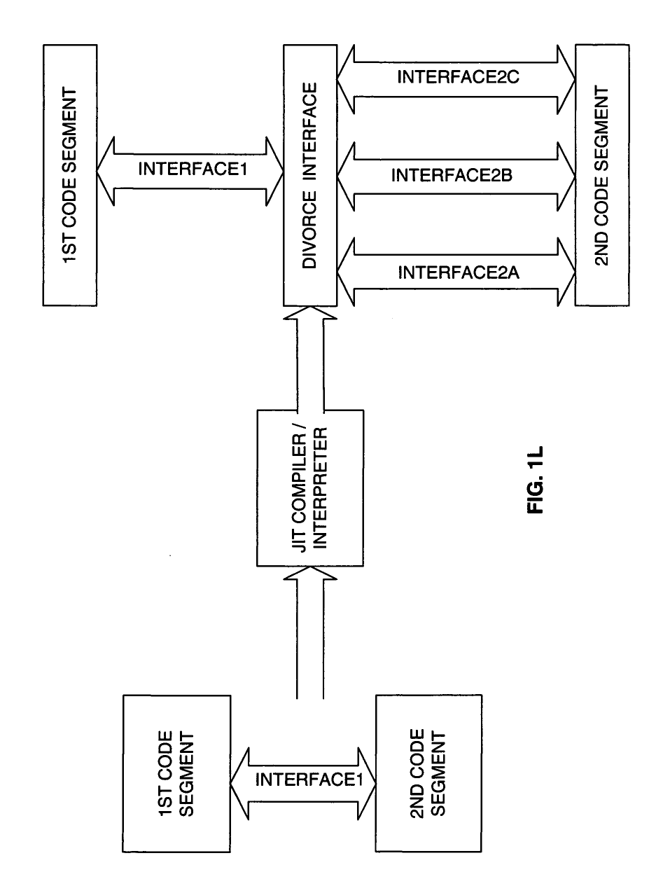

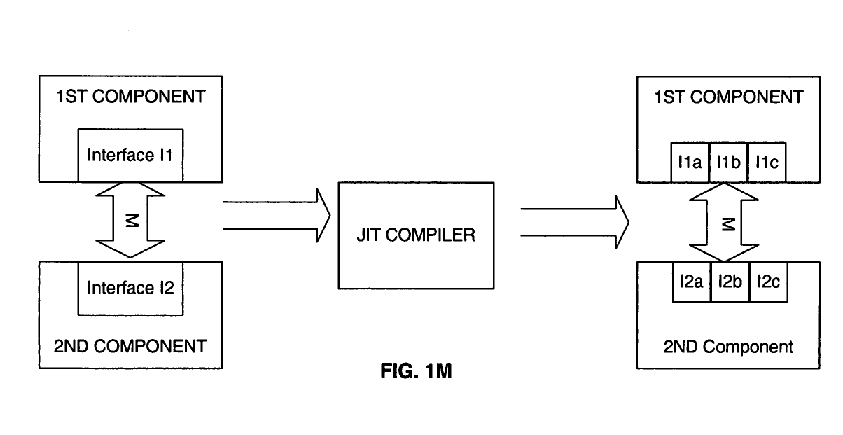

FIG. 1A illustrates an example of a suitable computing system environment in which the invention may be implemented. The computing system environment is only one example of a suitable computing environment and is not intended to suggest any limitation as to the scope of use or functionality of the invention. Neither should the computing environment of FIG. 1A be interpreted as having any dependency or requirement relating to any one or combination of components illustrated in the exemplary computing environment. Embodiments of the invention will also be described using as examples data structures found in various versions of the WINDOWS operating system. However, the invention is not limited to implementation in connection with a specific operating system.

The invention is operational with numerous other general purpose or special purpose computing system environments or configurations. Examples of well known computing systems, environments and/or configurations that may be suitable for use with the invention include, but are not limited to, personal computers, hand-held or laptop devices, multiprocessor systems, microprocessor-based systems, minicomputers, and the like. The invention is described in the general context of computer-executable instructions, such as program modules, being executed by a computer. Generally, program modules include routines, objects, components, data structures, etc. that perform particular tasks or implement particular abstract data types.

With reference to FIG. 1A, an exemplary system for implementing the invention includes a general purpose computing device in the form of a computer 1. Hardware components of computer 1 may include, but are not limited to, processing unit 2, system memory 4 and system bus 6 that couples various system components (including system memory 4) to processing unit 2. System bus 6 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus and Peripheral Component Interconnect (PCI) bus also known as Mezzanine bus.

Computer 1 typically includes a variety of computer readable media. Computer readable media can be any available media that can be accessed by computer 1 and includes both volatile and nonvolatile media, removable and non-removable media. By way of example, and not limitation, computer readable media may include computer storage media and communication media. Computer storage media includes volatile and nonvolatile, and removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 1. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

System memory 4 includes computer storage media in the form of volatile and/or nonvolatile memory such as read only memory (ROM) 8 and random access memory (RAM) 10. Basic input/output system 12 (BIOS), containing the basic routines that help to transfer information between elements within computer 1, such as during start-up, is typically stored in ROM 8. RAM 10 typically contains data and/or program modules that are immediately accessible to and/or presently being operated on by processing unit 2. By way of example, and not limitation, FIG. 1A illustrates operating system (OS) 14, application programs 16, other program modules 18 and program data 20.

Computer 1 may also include other removable/non-removable, volatile/nonvolatile computer storage media. By way of example only, FIG. 1A illustrates hard disk drive 22 that reads from or writes to non-removable, nonvolatile magnetic media, magnetic disk-drive 24 that reads from or writes to removable, nonvolatile magnetic disk 26 and optical disk drive 28 that reads from or writes to removable, nonvolatile optical disk 30 such as a CD ROM, CDRW, DVD or other optical media. Other removable/non-removable, volatile/nonvolatile computer storage media that can be used in the exemplary operating environment include, but are not limited to, magnetic tape cassettes, flash memory cards, digital video tape, solid state RAM, solid state ROM, and the like. Hard disk drive 22 is typically connected to system bus 6 through a non-removable memory interface such as interface 32, and magnetic disk drive 24 and optical disk drive 28 are typically connected to system bus 6 by a removable memory interface, such as interfaces 34 and 36.

The drives and their associated computer storage media, discussed above and illustrated in FIG. 1A, provide storage of computer readable instructions, data structures, program modules and other data for computer 1. In FIG. 1A, for example, hard disk drive 22 is illustrated as storing OS 38, application programs 40, other program modules 42 and program data 44. Note that these components can either be the same as or different from OS 14, application programs 16, other program modules 18 and program data 20. OS 38, application programs 40, other program modules 42 and program data 44 are given different numbers here to illustrate that, at a minimum, they are different copies. A user may enter commands and information into computer 1 through input devices such as keyboard 46, pointing device 48 (shown as a mouse, but which could be a trackball or touch pad) and stylus 71 (shown in conjunction with digitizer 65 ). Other input devices (not shown) may include a microphone, joystick, game pad, satellite dish, scanner, or the like. These and other input devices are often connected to processing unit 2 through user input interface 50 that is coupled to the system bus. Although mouse 48, keyboard 46, digitizer 65 and modem 66 are shown in FIG. 1A as connected to computer 1 through a serial port, these and other devices may be connected to computer 1 through other ports (e.g., a parallel port, PS/2 port, game port or a universal serial bus (USB) port) and related interfaces and structures. Monitor 52 or other type of display device is also connected to system bus 6 via an interface, such as video interface 54. In addition to the monitor, computers may also include other peripheral output devices such as speakers (not shown) and a printer (not shown), which may be connected through an output peripheral interface (not shown).

Computer 1 may operate in a networked environment using logical connections to one or more remote computers, such as remote computer 56. Remote computer 56 may be a personal computer, a server, a router, a network PC, a peer device or other common network node, and typically includes many or all of the elements described above relative to computer 1, although only memory storage device 58 has been illustrated in FIG. 1A. The logical connections depicted in FIG. 1A include local area network (LAN) 60 and wide area network (WAN) 62, but may also include other networks. Such networking environments are commonplace in offices, enterprise-wide computer networks, intranets and the Internet.

When used in a LAN networking environment, computer 1 is connected to LAN 60 through network interface or adapter 64. When used in a WAN networking environment, computer 1 may include modem 66 or other means for establishing communications over WAN 62, such as the Internet. Computer 1 may also access WAN 62 and/or the Internet via network interface 64. Modem 66, which may be internal or external, may be connected to system bus 6 via user input interface 50 or other appropriate mechanism. In a networked environment, program modules depicted relative to computer 1, or portions thereof, may be stored in the remote memory storage device. By way of example, and not limitation, FIG. 1A illustrates remote application programs 68 as residing on memory device 58. It will be appreciated that the network connections shown are exemplary and other means of establishing a communications link between computers may be used.

II. Example Programming Interfaces

A programming interface (or more simply, interface) may be viewed as any mechanism, process or protocol for enabling one or more segment(s) of code to communicate with or access the finctionality provided by one or more other segment(s) of code. Alternatively, a programming interface may be viewed as one or more mechanism(s), method(s), function call(s), module(s), object(s), etc. of a component of a system capable of communicative coupling to one or more mechanism(s), method(s), finction call(s), module(s), etc. of other component(s). The term “segment of code” in the preceding sentence is intended to include one or more instructions or lines of code, and includes, e.g., code modules, objects, subroutines, functions, and so on, regardless of the terminology applied or whether the code segments are separately compiled, or whether the code segments are provided as source, intermediate, or object code, whether the code segments are utilized in a runtime system or process, or whether they are located on the same or different machines or distributed across multiple machines, or whether the functionality represented by the segments of code are implemented wholly in software, wholly in hardware, or a combination of hardware and software. By way of example, and not limitation, terms such as application programming (or program) interface (API), entry point, method, finction, subroutine, remote procedure call, and component object model (COM) interface, are encompassed within the definition of programming interface.

A programming interface may be viewed generically as shown in FIG. 1B or FIG. 1C. FIG. 1B illustrates an interface Interfacel as a conduit through which first and second code segments communicate. FIG. 1C illustrates an interface as comprising interface objects I1 and I2 (which may or may not be part of the first and second code segments), which enable first and second code segments of a system to communicate via medium M. In the view of FIG. 1C, one may consider interface objects I1 and I2 as separate interfaces of the same system and one may also consider that objects I1 and I2 plus medium M comprise the interface. Although FIGS. 1B and 1C show bi-directional flow and interfaces on each side of the flow, certain implementations may only have information flow in one direction and/or may only have an interface object on one side.

Aspects of a programming interface may include the method whereby the first code segment transmits information (where “information” is used in its broadest sense and includes data, commands, requests, etc.) to the second code segment; the method whereby the second code segment receives the information; and the structure, sequence, syntax, organization, schema, timing and content of the information. In this regard, the underlying transport medium itself may be unimportant to the operation of the interface, whether the medium be wired or wireless, or a combination of both, as long as the information is transported in the manner defamed by the interface. In certain situations, information may not be passed in one or both directions in the conventional sense, as the information transfer may be either via another mechanism (e.g. information placed in a buffer, file, etc. separate from information flow between the code segments) or non-existent, as when one code segment simply accesses functionality performed by a second code segment. Any or all of these aspects may be important in a given situation, e.g., depending on whether the code segments are part of a system in a loosely coupled or tightly coupled configuration, and so this description should be considered illustrative and non-limiting.

The concept of a programming interface is known to those skilled in the art. There are various other ways to implement a programming interface. Such other ways may appear to be more sophisticated or complex than the simplistic view of FIGS. 1B and 1C, but they nonetheless perform a similar function to accomplish the same overall result. Some illustrative alternative implementations of a programming interface are described in connection with FIGS. 1D-1M.

Factoring. A communication from one code segment to another may be accomplished indirectly by breaking the communication into multiple discrete communications. This is depicted schematically in FIGS. 1D and 1E. As shown, some interfaces can be described in terms of divisible sets of finctionality. Thus, the interface functionality of FIGS. 1B and 1C may be factored to achieve the same result, just as one may mathematically provide 24, or 2 times 2 times 3 times 2. Accordingly, as illustrated in FIG. 1D, the finction provided by interface Interfacel may be subdivided to convert the communications of the interface into multiple interfaces Interface1A, Interface1B, Interface1C, etc. while achieving the same result. As illustrated in FIG. 1E, the function provided by interface II may be subdivided into multiple interfaces I1a, I1b, I1c, etc. while achieving the same result. Similarly, interface I2 of the second code segment which receives information from the first code segment may be factored into multiple interfaces I2a, I2b, I2c, etc. When factoring, the number of interfaces included with the 1st code segment need not match the number of interfaces included with the 2nd code segment. In either of the cases of FIGS. 1D and 1E, the functional spirit of interfaces Interface 1 and I1 remain the same as with FIGS. 1B and 1C, respectively. The factoring of interfaces may also follow associative, commutative, and other mathematical properties such that the factoring may be difficult to recognize. For instance, ordering of operations may be unimportant, and consequently, a finction carried out by an interface may be carried out well in advance of reaching the interface, by another piece of code or interface, or performed by a separate component of the system. Moreover, one of ordinary skill in the programming arts can appreciate that there are a variety of ways of making different function calls that achieve the same result.

Redefinition. In some cases, it may be possible to ignore, add or redefme certain aspects (e.g., parameters) of a programming interface while still accomplishing the intended result. This is illustrated in FIGS. 1F and 1G. For example, assume interface Interface1 of FIG. 1B includes a function call Square(input, precision, output), a call that includes three parameters (“input,” “precision” and “output”) and which is issued from the 1st Code Segment to the 2nd Code Segment. If the middle parameter (“precision”) is of no concern in a given scenario, as shown in FIG. 1F, it could be ignored, or replaced with another parameter. In either event, the functionality of Square can be achieved, so long as output is returned after input is squared by the second code segment. Precision may very well be a meaningful parameter to some downstream or other portion of the computing system; however, once it is recognized that precision is not necessary for the narrow purpose of calculating the square, it may be replaced or ignored. For example, instead of passing a valid precision value, a meaningless value such as a birth date could be passed without adversely affecting the result. Similarly, as shown in FIG. 1G, interface I1 is replaced by interface I1′, redefmed to ignore or add parameters to the interface. Interface I2 may similarly be redefmed (as interface I2′) to ignore unnecessary parameters, or parameters that may be processed elsewhere. As is clear from the foregoing, a programming interface may in some cases include aspects such as parameters which are not needed for some purpose, and which may be ignored, redefmed, or processed elsewhere for other purposes.

Inline Coding. It may also be feasible to merge some or all of the finctionality of two separate code modules such that the “interface” between them changes form. For example, the functionality of FIGS. 1B and 1C may be converted to the functionality of FIGS. 1H and 1I, respectively. In FIG. 1H, the previous 1st and 2nd Code Segments of FIG. 1B are merged into a module containing both of them. In this case, the code segments may still be communicating with each other but the interface may be adapted to a form which is more suitable to the single module. Thus, for example, formal Call and Return statements may no longer be necessary, but similar processing or response(s) pursuant to interface Interface1 may still be in effect. Similarly, shown in FIG. 1I, part (or all) of interface I2 from FIG. 1C may be written inline into interface I1 to form interface I1″. As illustrated, interface I2 is divided into I2a and I2b, and interface portion I2a has been coded in-line with interface I1 to form interface I1″.

Divorce. A communication from one code segment to another may be accomplished indirectly by breaking the communication into multiple discrete communications. This is depicted schematically in FIGS. 1J and 1K. As shown in FIG. 1J, one or more piece(s) of middleware (Divorce Interface(s), since they divorce finctionality and/or interface finctions from the original interface) are provided to convert the communications on the first interface, Interface1, to conform them to a different interface, in this case interfaces Interface2A, Interface2B and Interface2C. This might be done, e.g., where there is an installed base of applications designed to communicate with, say, an operating system in accordance with an Interface1 protocol, but then the operating system is changed to use a different interface, in this case interfaces Interface2A, Interface2B and Interface2C. The point is that the original interface used by the 2nd Code Segment is changed such that it is no longer compatible with the interface used by the 1st Code Segment, and so an intermediary is used to make the old and new interfaces compatible. Similarly, as shown in FIG. 1K, a third code segment can be introduced with divorce interface DI1 to receive the communications from interface I1 and with divorce interface DI2 to transmit the interface finctionality to, for example, interfaces I2a and I2b, redesigned to work with DI2, but to provide the same functional result. Similarly, DIl and DI2 may work together to translate the finctionality of interfaces I1 and I2 of FIG. 1C to a new operating system, while providing the same or similar functional result.

Rewriting. Yet another possible variant is to dynamically rewrite code to replace the interface functionality with something else but which achieves the same overall result. For example, there may be a system in which a code segment presented in an intermediate language (e.g. Microsoft IL, Java ByteCode, etc.) is provided to a Just-in-Time (JIT) compiler or interpreter in an execution environment (such as that provided by the .Net framework, the Java runtime environment, or other similar runtime type environments). The JIT compiler may be written so as to dynamically convert the communications from the 1st Code Segment to the 2nd Code Segment, i.e., to conform them to a different interface as may be required by the 2nd Code Segment (either the original or a different 2nd Code Segment). This is depicted in FIGS. 1L and 1M. As can be seen in FIG. 1L, this approach is similar to the Divorce scenario described above. It might be done, e.g., where an installed base of applications are designed to communicate with an operating system in accordance with an Interface1 protocol, but then the operating system is changed to use a different interface. The JIT Compiler could be used to conform the communications on the fly from the installed-base applications to the new interface of the operating system. As depicted in FIG. 1M, this approach of dynamically rewriting the interface(s) may be applied to dynamically factor, or otherwise alter the interface(s) as well.

It is also noted that the above-described scenarios for achieving the same or similar result as an interface via alternative embodiments may also be combined in various ways, serially and/or in parallel, or with other intervening code. Thus, the alternative embodiments presented above are not mutually exclusive and may be mixed, matched and combined to produce the same or equivalent scenarios to the generic scenarios presented in FIGS. 1B and 1C. It is also noted that, as with most programming constructs, there are other similar ways of achieving the same or similar functionality of an interface which may not be described herein, but nonetheless are represented by the spirit and scope of the invention.

III. Command Links

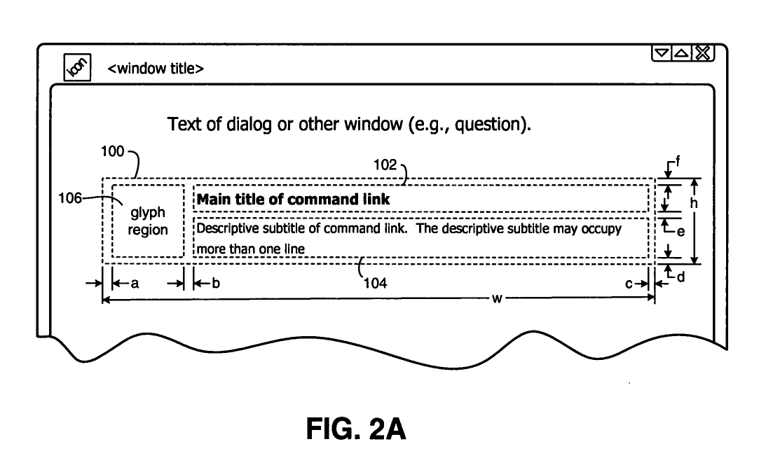

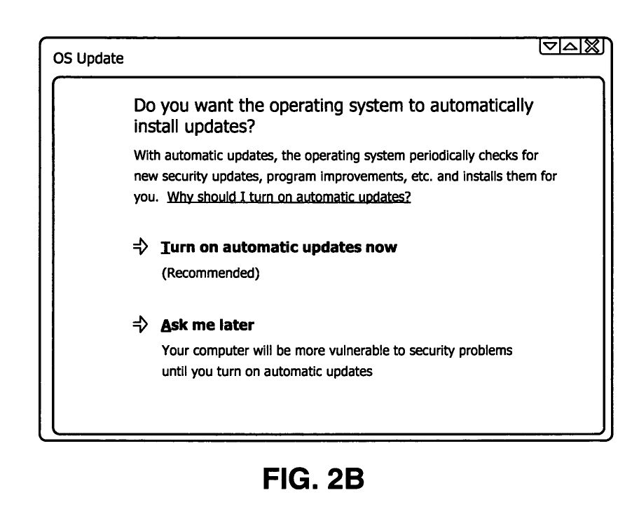

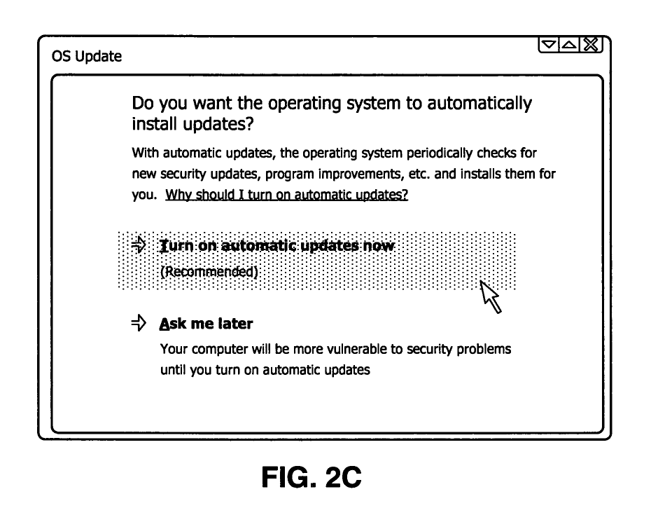

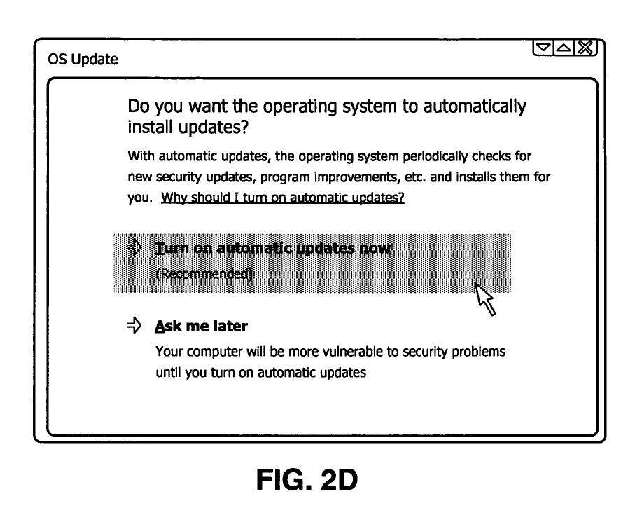

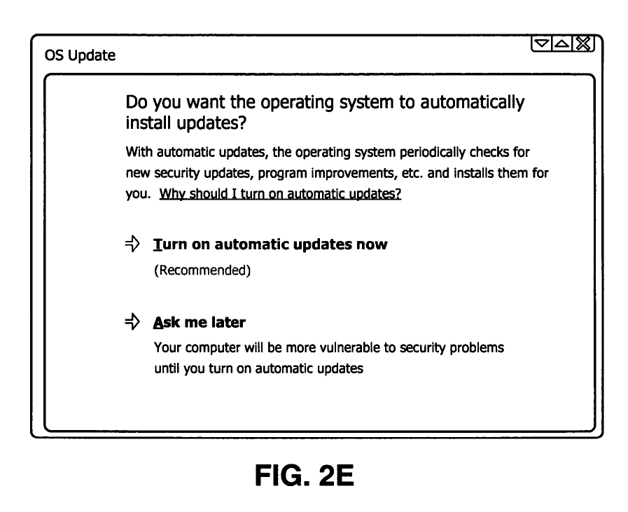

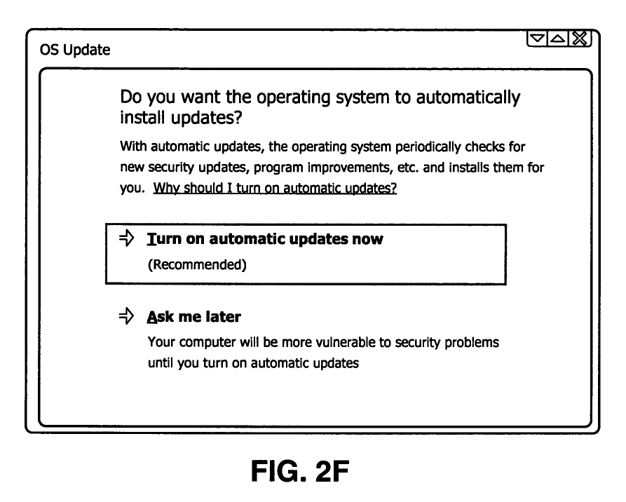

Shown in FIG. 2A is a generic command link 100 according to at least some embodiments of the invention. Command link 100 occupies a single contiguous region of a computer display. Command link 100 is divided into regions for glyph 106, main title 102, and subtitle 104. Each of these elements is described in more detail below. Although boundaries for command link 100 and for glyph 106, main title 102 and subtitle 104 are indicated in FIG. 2A with broken lines, this is for purposes of explanation. In practice, some or all of the region boundaries may not be shown on a display. The command links shown in FIGS. 2A-2F are all shown as located within independent dialog windows in a GUI generated by an OS (such as various versions of the WINDOWS OS). For example, a command link can be implemented in a task dialog user interface, as described in commonly owned U.S. patent application Ser. No. ______ (attorney docket no. 003797.01230, filed on the same date as the present application), titled “Task Dialog and Programming Interface for Same” and incorporated by reference herein. A command link could also be implemented in a task page dialog, as described in commonly owned U.S. patent application Ser. No. ______ (attorney docket no. 003797.01228, filed on the same date as the present application), titled “Dialog User Interfaces for Related Tasks and Programming Interface for Same” and incorporated by reference herein. A command link according to the invention might also be generated as part of other types of windows or portions thereof.

In at least some embodiments, the main title of a command link is a text string specified by the developer of a software program which requests creation of the command link (creation of command links is discussed in more detail below). The main instruction can be used as a primary indication of the action, choice or other option which corresponds to the command link. The main title may, and as shown in a subsequent example, be an answer to a question posed in the dialog. The subtitle is below the main title, and can be used to, e.g., provide supplemental information regarding the option indicated by the main title. In at least some embodiments, the main title text is in a bold font or otherwise rendered so as to be distinguishable from the subtitle text. A glyph may also be included as part of the command link. The glyph may be an icon specified by a software developer, can be a default icon supplied by an OS that generates the command link, or may be omitted altogether. If included, a glyph can be used to provide a user with an additional visual clue regarding the option corresponding to the command link.

In at least some embodiments, a command link is created according to a predefined format. That format specifies the relative locations of the glyph, main title and subtitle within a command link. In some embodiments, the glyph layout is reversed (with the glyph on the right side) for languages read from right to left. The command link format also specifies the maximum area within which a glyph can be included (box 106 in FIG. 2A). If a smaller glyph is used, the glyph region shrinks to the size of the smaller glyph. The command link format further specifies the left margin between the glyph left edge and the left side of the command link (dimension a in FIG. 2A), the margin between the glyph right edge and the left end of the main title (dimension b), the right margin between the right end of the main title (or subtitle, if the subtitle is longer) and the right side of the command link (dimension c in FIG. 2A), the top and bottom margins (dimensions f and d, respectively), and the margins between the main title and the subtitle (dimension e). Aside from these margins, the overall height (h) and/or width (w) of the command link may (within certain ranges) be specified by a developer. In some embodiments, the height h and/or width w automatically adjust to accommodate the glyph size and the text specified for the main title and the subtitle. In at least some embodiments, the top edge of the glyph is horizontally aligned with the top edge of the main title. The main title and subtitle may each include multiple lines of text, and the lower edge of the subtitle may extend beyond the lower edge of the glyph. The text styles (e.g., font, color, size, etc.) for the main title and the subtitle, the margins and other parameters described above, and/or the spacing separating command links may be specified in one or more theme files, as described below.

FIG. 2B is a more specific example of a command link. In the example of FIG. 2B, the dialog asks the user if he or she wishes the operating system to automatically install updates. A first command link has a main title “Turn on automatic updates now.” The subtitle indicates to the user that this is the option recommended. The second command link has a main title “Ask me later.” The subtitle for the second command link advises the user of the consequences of this option. Each of the command links in FIG. 2B has a glyph. As indicated above, a glyph may be omitted for one or both links. If both links include a glyph, the links can use the same glyph or could each use different glyphs. Although both command links in FIG. 2B have subtitles, a subtitle could also be omitted at the option of a software developer. In at least some embodiments, at least two command links are shown whenever command links are used. However, more than two command links may be displayed in a dialog or other UI.

FIGS. 2C-2F show how the appearance of a command link may be altered in certain circumstances. In FIG. 2B, both command links are in a “rest” state, i.e., a user has not hovered a mouse cursor over either command link or otherwise provided input (e.g., tabbing, as described below) indicating the user is potentially about to select one of those links. In FIG. 2C, a cursor has been moved over the first command link, which is now in a “hover” state. In this state, the background color of the command link changes. In FIG. 2C, this change in color is shown with stippling. In this manner, the user can easily see which text is part of the command link (and thereby related to the option corresponding to the command link). In at least some embodiments, a user can also place a command link in a “hover” state by tabbing to the command link in a manner similar to that in which a user can press the tab key to reach conventional button controls. In FIG. 2D, the user has selected the first command link by, e.g., pressing a mouse button after hovering the cursor over the command link. Upon selection, the command link background changes to a third color (different from the color of the rest or hover states). This different color is shown in FIG. 2D with a denser stippling pattern than that used in FIG. 2C. In at least some embodiments, a command link can also be selected by pressing the “enter” key or the space bar after tabbing to that command link. The command link background colors for hover and selected states can also be specified by the previously mentioned theme file(s). In FIG. 2E, a command link is in a disabled stated. This is similar to “graying out” of conventional button (and other UI) controls, and can be used where a particular option might not currently be available.

Although FIGS. 2C and 2D show highlighting of a command link by changing a background color, the invention is not limited in this regard. For example, a command link could also be highlighted by drawing a border around the command link, as shown in FIG. 2F. Different types of borders could be used for different states (e.g., one for hover, one for selected, etc.). In some embodiments, a border could be used to indicate that a command link has received keyboard focus. In other words, a border around the command link could indicate that the user will select the command link if the “enter” key is pressed. A command link could receive keyboard focus if the user tabs to that command link. A command link could also receive keyboard focus automatically (e.g., if the command link is designated as a default choice by a program). Borders could also be used in conjunction with background color changes.

In at least some embodiments, a command link changes to the “press” state color when a user presses a mouse button, but the user must press and then release the mouse button in order to actually select the command link. If a user places a cursor over a command link, presses a mouse button, and then moves the cursor off of the command link while pressing the mouse button, the command link is not selected. In such a case, the command link would return to the rest state. In some embodiments, after a user moves the cursor off the command link while holding a mouse button down, the command link receives keyboard focus.

In at least some embodiments, a command link can be used in a manner similar to the conventional button control of various versions of the WINDOWS OS. In other words, user selection of a command link can be treated by an application program in a manner similar to user selection of a conventional button, and can be used for initiating a command or some other event. Command links can also have corresponding “hot keys,” or keys which a user can press (perhaps in combination with an ALT or other key) to select the command link. In FIG. 2B, for example, the leading “T” in the main title of the first command link is underlined to indicate that the “T” key is the hot key for that command link.

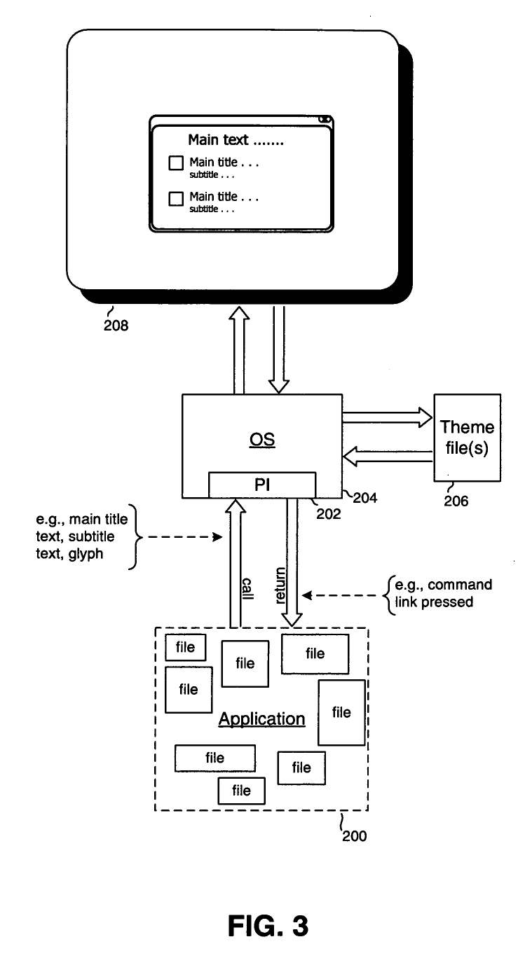

FIG. 3 shows, in diagrammatic form, how an application program can cause an OS to create command links according to at least some embodiments. Shown at the bottom of FIG. 3 is a block representing an arbitrary application program 200. Because application programs typically include a plurality of separate program files and other components, application program 200 is shown in FIG. 3 as a broken line box surrounding multiple solid line boxes, with each of the solid line boxes representing separate files. More than one of those individual files may be able to request creation of a command link, and such a request may include handles, pointers or other references to data within other files of application program 200.

Application 200 requests generation of a command link by transmitting that request to programming interface (PI) 202. Although shown in FIG. 3 as a part of OS 204, PI 202 can be implemented in various of the manners described in connection with FIGS. 1B through 1M. PI 202 includes one or more finctions or methods which application 200 accesses through one or more calls. Included in the call(s) are parameters, flags and other elements providing the information (or references to the information) which OS 204 will use to generate a command link. That information includes, for each requested command link:
the text for the main title of the command link,
the text for the subtitle of the command link (if there is to be a subtitle), and
if a glyph is to be displayed, and if so, the identity of that glyph.

The information set forth above may be provided directly (i.e., as a value passed as part of the fiction call), indirectly (i.e., as a handle of or pointer to a variable, structure or other object), or both.

Using information received by PI 202 from application program 200, OS 204 automatically generates each requested command link so that the main title will be prominently displayed and distinguished from the subtitle (if there is a subtitle), so that the main title, subtitle (if any) and glyph (if any) have the arrangement and spacing defined by the command link format, so that the proper styles are applied, etc. OS 204 may also automatically size the command link(s) based on the specified text. As previously indicated, the styles of command link text, the spacing of various command link elements, and other aspects of the visual appearance of a command link are controlled by parameters of one or more theme files 206. Accordingly, application 200 is not required to include extensive layout and other formatting data in the function call(s). In this manner, all command links have a consistent layout and appearance.

When a user hovers a cursor over a command link, OS 204 changes the appearance of the command link to indicate the “hover” state. Similarly, OS 204 changes the appearance of a command link when a user selects that link. When a user does select a command link, OS 204 returns data regarding that selection, via PI 202, to application 200. Application 200 then processes that data in a manner defined by the developer of the application.

In at least some embodiments of the invention implemented using versions of the WINDOWS OS, a command link is a standard control which an application can request using many of the same PIs that are used to create a conventional button control. For example, a command link can be created using the CreateWindow function. Because the CreateWindow function is known in the art, it is not extensively discussed herein. Details of the CreateWindow function are available from, e.g., <http://msdn.microsoft.com>. In general, however, the CreateWindow function generates a command link in a manner similar to that in which a conventional button control is generated. Specifically, the command link (like a conventional button) is effectively a smaller “child” window that is created within a dialog or other type of “parent” window. The CreateWindow finction specifies a window class, window title, window style and (optionally) the initial position and size of the command link window. The finction also specifies the command link window's parent and the command link window identifier.

The following sample of code shows one way in which a command link having the main title “My Command Link,” a default glyph and no subtitle can be displayed using the CreateWindow function.

### EXAMPLE (1)

```
HWND hwndCommandLink = CreateWindow(WC_BUTTON,
                            TEXT(“My
                            Command Link”), WS_CHILD |
                            WS_VISIBLE |
                            BS_COMMANDLINK | BS_NOTIFY,
                            cxChar, cyChar+60, 240, 140, hwnd,
                            (HMENU)3, hInstance, NULL);
```

In the above sample, “WC₁₃ BUTTON” is a pointer to a class of windows. In this case, it is a pointer to a class of windows that are rendered as buttons. The parameter “TEXT(“My Command Link”)” specifies the text to be included as the main title of the command link. Alternatively, a pointer to a text string could be used. The flags “WS_CHILD” and “WS_VISIBLE” specify known window styles in existing versions of the WINDOWS OS (respectively, a child window and a window that is initially visible). The flag “BS_NOTIFY” also specifies an existing style (i.e., enabling a button to send BN_KILLFOCUS and BN_SETFOCUS notification messages to a parent window). The parameters “cxChar” and “cyChar+60” specify the initial position of the command link. The parameters “240” and “140” specify the width and height of the command link. The parameter “hwnd” is a handle to the parent or owner window of the command link (e.g., a dialog in which the command link is contained). The parameter “(HMENU)3” is a child window identifier used by a dialog box control to notify its parent about events (e.g., user selection, hovering of a cursor, etc.). The “hinstance” parameter can be ignored. The “BS_COMMANDLINK” flag specifies that a button should be rendered as a command link.

Set forth below is a sample of code which changes the glyph of the command link in Example (1) to “glyph.bmp”.

### EXAMPLE (2)

```
//obtain the initial image list of the command link
if(Button_GetImageList(hwndCommandLink, &buttonImageList))
        {
              //load image to a new image list
              HIMAGELIST hImageList =
              ImageList_LoadImage(NULL,
              L“glyph.bmp”, 30, 1, CLR_DEFAULT,
              IMAGE_BITMAP,
              LR_DEFAULTCOLOR | LR_LOADFROMFILE);
              //attach image to button image list
              buttonImageList.himl = hImageList;
              //set image list to button
              if(!Button_SetImageList(hwndCommandLink,
              &buttonImageList))
                    PrintText(hWnd, L“Can't set a new glyph
                    image”);
        }
```

As persons skilled in the art will appreciate, the above code sample replaces the default glyph with “glyph.bmp” using existing PIs that could be used to associate images with conventional button controls. An alternative manner of replacing a default glyph with “glyph.bmp” (also using existing PIs) is set forth below.

### EXAMPLE (3)

```
BUTTON_IMAGELIST buttonImageList = { 0 };
  buttonImageList.himl =
  ImageList_LoadImage(NULL, L“glyph.bmp”, 30, 1,
  CLR_DEFAULT, IMAGE_BITMAP, LR_DEFAULTCOLOR |
  LR_LOADFROMFILE);
  if(!Button_SetImageList(hwndCommandLink, &buttonImageList))
        PrintText(hWnd, L“Can't set a new glyph image”);
```

Because a command link includes features not associated with conventional buttons, several programming interfaces are needed in addition to those used with conventional button controls. Specifically, conventional buttons only include a single text string, and do not have a subtitle. Attached hereto are Appendices A through F describing various macros and messages pertaining to the subtitle portions of a command link (a subtitle is referred to as a “note” in the appendices). Because these appendices will be understood by persons skilled in the art, extensive discussion is not included herein. However, set forth below is a sample of code using the “Button_SetNote” macro to specify “This is the subtitle” as the subtitle of the command link created in example (1) above.

### EXAMPLE (4)

Button_SetNote(hwndCommandLink, L “This is the subtitle”)

Additional programming interfaces can also be used to specify that a command link should not contain a glyph. As but one example, a variable (e.g., “CommandLink Glyph”) could be included in a function call and given a value of “true” if a glyph is to be displayed or “false” if no glyph is to be displayed. As but another possible alternative, a value of “−1” or of some predetermined flag (e.g., “CL_NOGLYPH”) for buttonImageList.himl in example (3) could be defined as a request to not display a glyph.

As indicated above, a command link is automatically sized by the OS in at least some embodiments of the invention. If a command link is too small, there may be insufficient room for all specified text, and needed information may not be displayed.

If a command link is too large, the control may be aesthetically undesirable and/or waste screen area. In some embodiments, a command link either has a default or a specified width. Using that width, the OS then calculates an appropriate height for the command link. In at least some embodiments, an application can also ask the OS to report an ideal size for a command link. The existing BCM_GETIDEALSIZE message in various versions of the WINDOWS OS can be used for this purpose. When used in connection with a conventional button control, the BCM_GETIDEALSIZE message passes the OS a handle to a conventional button control for which an ideal size is to be calculated. In response, the OS calculates that size (based on the text and image list referenced with the passed button handle), and then returns that size to the calling application. In order to obtain the ideal size for a command link, the same BCM_GETIDEALSIZE message format can be used to pass a handle to a command link. In response, the OS calculates an ideal size based on predefmed values for command link margins (e.g., dimensions a-f in FIG. 2A) and on the main title, subtitle (if any) and glyph (if any) for the command link referenced with the passed handle. The OS then reports the calculated ideal size to the calling application.

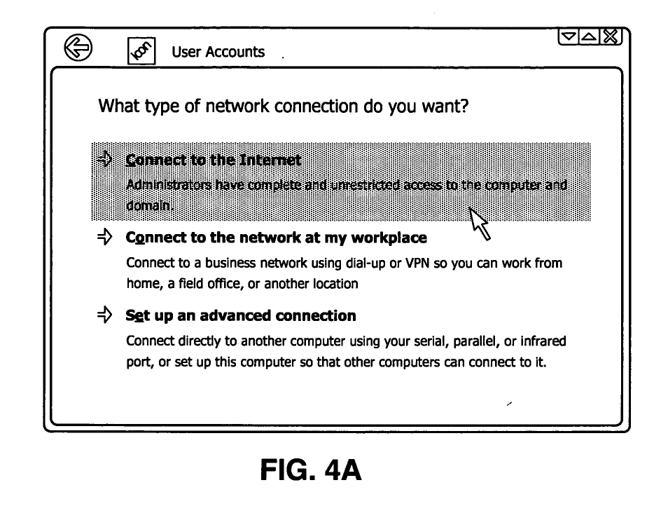

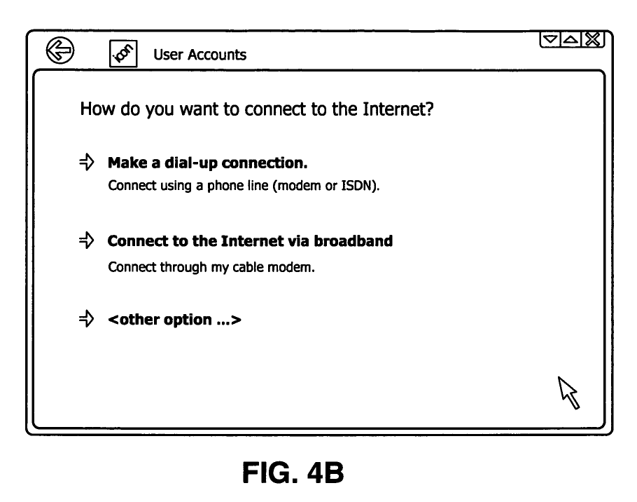

FIGS. 4A and 4B illustrate advantages of command links according to at least some embodiments of the invention. In FIG. 4A, a user is presented with a dialog asking the user what type of connection is desired, and the user has selected the first option (“Connect to the Internet”). When the user selects one of the command links, the dialog is completed, and the user receives an indication of same on the computer display. As shown in FIG. 4B, for example, the user is immediately taken to a subsequent dialog so that the user can provide additional information about the desired connection. Unlike prior art “radio button” controls, the user was not required to select an option in FIG. 4A and then select a second “ok” button (or other control) to complete the first dialog. Of course, a user would not necessarily be taken to a subsequent dialog after selection of a command link. For example, and depending on the purpose of a dialog having the selected command link, the user might know a dialog has been completed by being returned to a desktop or to another previously active application window.

Although specific examples of carrying out the invention have been described, those skilled in the art will appreciate that there are numerous other variations and permutations of the above described systems and techniques. These and other variations fall within the spirit and scope of the invention as set forth in the appended claims. As used in the claims, the phrase “data indicative of” includes pointers or other references to data located elsewhere, as well as the actual data itself. In the claims, various portions are prefaced with letter or number references for convenience. However, use of such references does not imply a temporal relationship not otherwise required by the language of the claims.

Appendix A

Button GetNote Macro

The Button_GetNote macro retrieves the note text. You can use this macro or send the BCM_GETNOTE message explicitly.

```
Syntax
BOOL Button_GetNote(
      HWND hwnd,
      PWSTR pSz,
      DWORD *pCc
);
```

Parameters
hwnd
Handle to the command link control.
pSz
Pointer to buffer to store the note text.
pCc
Pointer to a buffer size (should be bigger than or equal to command link note size). It will contain the actual size if macro succeeds
   Return Value
If the macro succeeds, it returns TRUE. Otherwise it returns FALSE.
   Remarks
This macro is applicable to Command Links.
Note To use this API, you must provide a manifest specifying Comclt32.dl1 version 6.0. For more information on manifests, see Using Windows XP Visual Styles.
<http://msdn.microsoft.com/library/en-us/shellcc/platform/commctls/userex/cookbook.asp>
   Macro Information
Header Declared in Commctrl.h
   Appendix B
   Button SetNote Macro

The Button_SetNote macro sets the note text. You can use this macro or send the BCM_SETNOTE message explicitly.

```
Syntax
BOOL Button_SetNote(
      HWND hwnd,
      PWSTR pSz
);
```

Parameters
hwnd
Handle to the command link control.
pSz
Pointer to buffer with a text for note.
   Return Value
If the macro succeeds, it returns TRUE. Otherwise it returns FALSE.
   Remarks
This macro is applicable to Command Links.
Note To use this API, you must provide a manifest specifying Comclt32.dl1 version 6.0. For more information on manifests, see Using Windows XP Visual Styles.
<http://msdn.microsoft.com/1ibrary/en-us/shellcc/platform/commctls/userex/cookbook.asp>
   Macro Information
Header Declared in Commctrl.h
   Appendix C
   Button GetNoteLength Macro
The Button_GetNoteLength macro retrieves the note size. You can use this macro or send the

BCM_GETNOTELENGTH message explicitly.

Syntax
LRESULT Button_GetNoteLength(
HWND hwnd,
);

Parameters
hwnd
Handle to the command link control.
   Return Value
If the macro succeeds, it returns the note size. Otherwise it returns 0.
   Remarks
This macro is applicable to Command Links.
Note To use this API, you must provide a manifest specifying Comclt32. dl1 version 6.0. For more information on manifests, see Using Windows XP Visual Styles.
<http://msdn.microsoft.com/library/en-us/shellcc/platform/commctls/userex/cookbook.asp>
   Macro Information
Header Declared in Commctrl.h
   Appendix D
   BCM GETNOTE Message
The BCM_GETNOTE message retrieves the string which contains a note of command link control.
   Syntax

To send this message, call the SendMessage finction as follows.

```
lResult = SendMessage(  // returns LRESULT in lResult
  (HWND) hWndControl,  // handle to destination control
  (UINT) BCM_GETNOTE,  // message ID
  (WPARAM) wParam,  // = (WPARAM) (DWORD *)
                              &ccBuffer;
  (LPARAM) lParam  // = (LPARAM) (PWSTR) pSz;
);
```

Parameters
wParam
Pointer to a buffer size (should be bigger than or equal to command link note size). It will contain the actual size if message send succeeds.
lParam
Pointer to buffer to store the note text.
   Return Value
If the message succeeds, it returns TRUE. Otherwise it returns FALSE.
   Remarks
Note To use this API, you must provide a manifest specifying Comclt32. dl1 version 6.0. For more information on manifests, see Using Windows XP Visual Styles. <http://msdn.microsoft.com/1ibrary/en-us/shellcc/platform/commctls/userex/cookbook.asp>
   Message Information
Header Declared in Commctrl.h
   Appendix E
   BCM SETNOTE Message
The BCM_SETNOTE message sets a note for command link control.
   Syntax

To send this message, call the SendMessage function as follows.

```
lResult = SendMessage(  // returns LRESULT in lResult
  (HWND) hWndControl,  // handle to destination control
  (UINT) BCM_SETNOTE,  // message ID
  (WPARAM) wParam,  // = 0; not used, must be zero
  (LPARAM) lParam  // = (LPARAM) (PWSTR) pSz;
);
```

Parameters
wParam
Not used; must be zero.
lParam
Pointer to buffer with a text for note.
   Return Value
If the message succeeds, it returns TRUE. Otherwise it returns FALSE.
   Remarks
   Note To use this API, you must provide a manifest specifying Comclt32. dll version 6.0. For more information on manifests, see Using Windows XP Visual Styles. <http://msdn.microsoft.com/library/en-us/shellcc/platform/commctls/userex/cookbook.asp>
   Message Information
Header Declared in Commctrl.h
   Appendix F
   BCM GETNOTELENGTH Message
The BCM_GETNOTELENGTH message retrieves the note size.
   Syntax

To send this message, call the SendMessaze function as follows.

```
lResult = SendMessage(  // returns LRESULT in lResult
  (HWND) hWndControl,  // handle to destination control
  (UINT) BCM_SETNOTE,  // message ID
  (WPARAM) wParam,  // = 0; not used, must be zero
  (LPARAM) lParam  // = 0; not used, must be zero;
);
```

Parameters
wParam
Not used; must be zero.
lParam
Not used; must be zero.
   Return Value
If the message succeeds, it returns the note size. Otherwise it returns 0.
   Remarks
Note To use this API, you must provide a manifest specifying Comclt32.dl1 version 6.0. For more information on manifests, see Using Windows XP Visual Styles.
<http://msdn.microsoft.com/library/en-us/shellcc/platform/commctls/userex/cookbook.asp >.
   Message Information
Header Declared in Commctrl.h

1. A method of receiving user input in a computer system having a graphical user interface including a display, comprising the steps of:
(a) displaying, within a first contiguous region of the display, a first input control, the first input control including:
(i) a main title portion including text providing a description of the first input control, and
(ii) a subtitle portion, the subtitle portion including text providing additional information about the first input control, the subtitle portion text being less prominent than the main portion text;
(b) receiving user input indicative of selection or potential selection of the first input control; and
(c) highlighting the first input control, in response to the input of step (b), by altering the appearance of the first contiguous display region.

2. The method of claim 1, wherein the first input control further includes a glyph located within the contiguous display region.

3. The method of claim 1, wherein:
step (a) comprises displaying the first input control within a portion of a dialog user interface,
step (b) comprises receiving user input indicative of selection of the first input control, and further comprising the step of
(d) displaying, without requiring selection by the user of any additional user input controls, a visual indication that the dialog user interface portion is completed.

4. The method of step 3, further comprising the step of
(d) displaying a second user input control within a second contiguous region of the display, the second input control including a main title portion providing a description of the second input control, and wherein
step (a) further comprises displaying a main instruction to the user as part of the dialog user interface, the main instruction posing a question to the user answerable by selection of either the first or the second input controls.

5. The method of claim 1, wherein:
step (b) comprises receiving user input indicative of potential selection of the first input control, and
step (c) comprises altering the appearance of the first contiguous region in a first manner, and further comprising the steps of
(d) receiving user input indicative of selection of the first input control; and
(e) highlighting the first input control, in response to the input of step (d), by altering the appearance of the first contiguous region in a second manner, the second manner being different from the first manner.

6. The method of claim 5, further comprising the steps of:
(f) displaying a border around the first contiguous region as an indication of the first input control being selectable by the user pressing a designated keyboard key.

7. The method of claim 1, wherein
step (a) comprises displaying the first input control within a portion of a dialog user interface, the dialog user interface including a main instruction to the user posing a question answerable by selection of either the first input control or a second input control,
step (b) comprises receiving user input indicative of potential selection of the first input control,
step (c) comprises altering the appearance of the first contiguous region to have a first background color, and further comprising the steps of
(d) displaying the second input control within a second contiguous region of the display, the second input control including a main title portion providing a description of the second input control;
(e) receiving user input indicative of selection of the second input control;
(f) highlighting the second input control, in response to the input of step (e), by altering the appearance of the second contiguous region to have a second background color, the second background color being different from the first background color; and
(g) displaying, without requiring selection by the user of any additional user interface input controls, and in response to the input of step (e), a visual indication that the dialog user interface portion is completed.

8. The method of claim 1, wherein step (c) comprises highlighting the first input control by placing a border around at least part of the first contiguous display region.

9. A computer-readable medium having stored thereon data representing sequences of instructions which, when executed by a processor, cause the processor to perform steps of a method for receiving user input in a computer system having a graphical user interface including a display, said steps comprising:
(a) displaying, within a first contiguous region of the display, a first input control, the first input control including:
(i) a main title portion including text providing a description of the first input control, and
(ii) a subtitle portion, the subtitle portion including text providing additional information about the first input control, the subtitle portion text being less prominent than the main portion text;
(b) receiving user input indicative of selection or potential selection of the first input control; and
(c) highlighting the first input control, in response to the input of step (b), by altering the appearance of the first contiguous display region.

10. The computer-readable medium of claim 9, wherein the first input control further includes a glyph located within the contiguous display region.

11. The computer-readable medium of claim 9, wherein:
step (a) comprises displaying the first input control within a portion of a dialog user interface,
step (b) comprises receiving user input indicative of selection of the first input control, and comprising further instructions for performing steps comprising
(d) displaying, without requiring selection by the user of any additional user input controls, a visual indication that the dialog user interface portion is completed.

12. The computer-readable medium of step 11, comprising further instructions for performing steps comprising
(d) displaying a second user input control within a second contiguous region of the display, the second input control including a main title portion providing a description of the second input control, and wherein
step (a) f1urther comprises displaying a main instruction to the user as part of the dialog user interface, the main instruction posing a question to the user answerable by selection of either the first or the second input controls.

13. The computer-readable medium of claim 9, wherein:
step (b) comprises receiving user input indicative of potential selection of the first input control, and
step (c) comprises altering the appearance of the first contiguous region in a first manner, and comprising further instructions for performing steps comprising
(d) receiving user input indicative of selection of the first input control; and
(e) highlighting the first input control, in response to the input of step (d), by altering the appearance of the first contiguous region in a second manner, the second manner being different from the first manner.

14. The computer-readable medium of claim 13, comprising further instructions for performing steps comprising:
(f) displaying a border around the first contiguous region as an indication of the first input control being selectable by the user pressing a designated keyboard key.

15. The computer-readable medium of claim 9, wherein
step (a) comprises displaying the first input control within a portion of a dialog user interface, the dialog user interface including a main instruction to the user posing a question answerable by selection of either the first input control or a second input control,
step (b) comprises receiving user input indicative of potential selection of the first input control,
step (c) comprises altering the appearance of the first contiguous region to have a first background color, and comprising further instructions for performing steps comprising
(d) displaying the second input control within a second contiguous region of the display, the second input control including a main title portion providing a description of the second input control;
(e) receiving user input indicative of selection of the second input control;
(f) highlighting the second input control, in response to the input of step (e), by altering the appearance of the second contiguous region to have a second background color, the second background color being different from the first background color; and
(g) displaying, without requiring selection by the user of any additional user interface input controls, and in response to the input of step (e), a visual indication that the dialog user interface portion is completed.

16. The computer-readable medium of claim 9, wherein step (c) comprises highlighting the first input control by placing a border around at least part of the first contiguous display region.

17. A software architecture for generating input controls in a computer system having a graphical user interface including a display, comprising:
at least one component configured to generate an input control on the display, wherein
(i) the at least one component includes at least one theme file containing data controlling display parameters of the generatable input control,
(ii) the generatable input control has a format defined by the at least one component, the format including a main title having text, the size and location of the main title within a first contiguous display region being specified by the at least one theme file, and
(iii) the format further includes a subtitle portion, the subtitle portion including text being less prominent than the main title text, the subtitle text sized and located within the first contiguous display region so as to be distinguishable from and less prominent than the main title text, the size and location of the subtitle text being specified by the at least one theme file; and
(b) at least one application program interface to access the at least one component, the at least one application program interface configured to receive data indicative of text for a main title and data indicative of text for a subtitle.

18. The software architecture of claim 17, wherein the format further includes a glyph, the size and location of the glyph within the first contiguous display region being specified by the at least one theme file.

19. The software architecture of claim 17, wherein the format further includes, subsequent to displaying the input control and receiving user input indicative of potential selection of the input control, highlighting the input control in response to said user input by altering the appearance of the first contiguous display region.

20. The software architecture of claim 19, wherein the format further includes altering the appearance of the first contiguous display region in a first manner upon receiving user input indicative of potential selection of the input control, and altering the appearance of the first contiguous display region in a different manner upon receiving user input indicative of selection of the input control.
